(19) United States
(12) Patent Application Publication
(10) Pub. No.: US 2004/0207604 A1
(43) Pub. Date: Oct. 21, 2004

(54) Portable electronic device with a concealable keyboard module

(75) Inventor: Ko-Chien Chuang, Taipei-city (TW)

Correspondence Address: BACON & THOMAS, PLLC, 625 SLATERS LANE, FOURTH FLOOR, ALEXANDRIA, VA, 22314

(73) Assignee: COMPAL ELECTRONICS, INC., Taipei City (TW)

(21) Appl. No.: 10/445,925

(22) Filed: May 28, 2003

(30) Foreign Application Priority Data
Apr. 17, 2003 (TW) 092206062

(51) Int. Cl. G09G 5/00

(52) U.S. Cl. 345/168

(57) ABSTRACT

A personal digital assistant includes host and keyboard modules. The host module includes a housing with a first lateral side, a second lateral side opposite to the first lateral side in a first direction, a keyboard-accommodating cavity extending from the first lateral side toward the second lateral side, and an access opening formed in the first lateral side for access into the keyboard-accommodating cavity. The host module further includes a host circuit disposed in the housing. The keyboard module is coupled electrically to the host circuit and is slidably disposed in the keyboard-accommodating cavity. The keyboard module is extendable out of and retractable into the keyboard-accommodating cavity through the access opening.

### BACKGROUND OF THE INVENTION

1. Field of the Invention

The invention relates to a portable electronic device, more particularly to a portable electronic device with a concealable keyboard module.

2. Description of the Related Art

A conventional personal digital assistant includes a touch-control display module with displaying and writing portions. The writing portion allows a user to input information by script writing or drawing directly thereon, or by tapping on a simulated keyboard displayed on the writing portion. The input information is then shown on the displaying portion. The conventional personal digital assistant is configured with software for character recognition of script writing.

Although the conventional personal digital assistant can achieve its intended purpose, the writing portion of the conventional personal digital assistant, when in use, occupies a substantial area of the display module that can be used instead for the displaying portion. Moreover, due to the relatively small size of the writing portion, it is quite inconvenient for the user to input information. Further, the input efficiency using character recognition software available in the market up to this date is relatively low as compared to a mechanical keyboard.

### SUMMARY OF THE INVENTION

Therefore, the object of the present invention is to provide a portable electronic device, such as a personal digital assistant, that has a concealable keyboard module so as to overcome the aforesaid drawbacks of the prior art.

According to the present invention, a portable electronic device, such as a personal digital assistant, includes host and keyboard modules. The host module includes a housing with a first lateral side, a second lateral side opposite to the first lateral side in a first direction, a keyboard-accommodating cavity extending from the first lateral side toward the second lateral side, and an access opening formed in the first lateral side for access into the keyboard-accommodating cavity. The host module further includes a host circuit disposed in the housing. The keyboard module is coupled electrically to the host circuit and is slidably disposed in the keyboard-accommodating cavity. The keyboard module is extendable out of and retractable into the keyboard-accommodating cavity through the access opening.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of the first preferred embodiment of a portable electronic device according to the present invention;

FIG. 2 is a block diagram illustrating a host circuit, a keyboard module, and a display module of the first preferred embodiment;

FIG. 3 is a fragmentary schematic view of the keyboard module of the first preferred embodiment;

FIG. 4 is a schematic view of the second preferred embodiment of a portable electronic device according to the present invention; and

FIG. 5 is a fragmentary schematic view of a second keyboard module of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

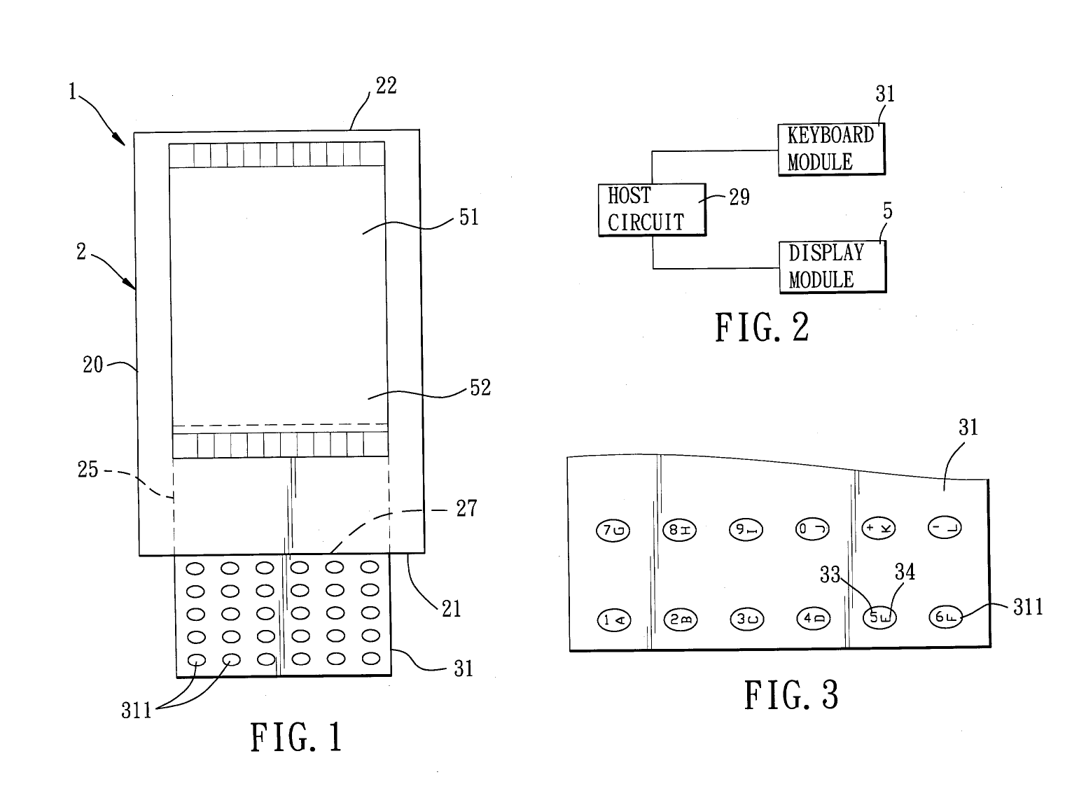

Referring to FIGS. 1 to 3, the first preferred embodiment of a portable electronic device 1 is shown to include a host module 2 and a keyboard module 31.

The host module 2 includes a housing 20 with a first lateral side 21, a second lateral side 22 opposite to the first lateral side 21 in a first direction, a keyboard-accommodating cavity 25 that extends from the first lateral side 21 toward the second lateral side 22, and an access opening 27 formed in the first lateral side 21 for access into the keyboard-accommodating cavity 25.

The housing 20 of the host module 2 further has a display surface between the first and second lateral sides 21, 22. The host module 2 further includes a host circuit 29 disposed in the housing 20. The portable electronic device 1 further comprises a display module 5 disposed on the display surface of the housing 20 and coupled electrically to the host circuit 29. In this embodiment, the host circuit 29 is configured with proprietary software to enable operation of the display module 5 in a first displaying mode, where the display module 5 is oriented parallel to the first direction, and a second displaying mode, where the display module 5 is oriented in a second direction transverse to the first direction. In this embodiment, the host module 2 is embodied in a personal digital assistant. In other embodiments, the host module 2 can be embodied in a tablet personal computer or an electronic dictionary.

As in the conventional personal digital assistant, the display module 5 has input and output interface functions. The display module 5 is provided with displaying and writing portions 51, 52 so that a user can input information by script writing and/or drawing directly on the writing portion 52, or by tapping on a simulated keyboard (not shown) displayed on the writing portion 52. The input information is then shown on the displaying portion 51 of the display module 5.

The keyboard module 31 is coupled electrically to the host circuit 29, is slidably disposed in the keyboard-accommodating cavity 25, and includes a plurality of keys 311. In this embodiment, the host circuit 29 is configured with proprietary software to assign each of the keys 311 of the keyboard module 31 with a first definition when the display module 5 is operated in the first displaying mode, and with a second definition when the display module 5 is operated in the second displaying mode. Moreover, each of the keys 311 of the keyboard module 31 is provided with a first character 33 oriented in the first direction and a second character 34 oriented in the second direction, as best shown in FIG. 3. As such, the user can conveniently refer to the first character 33 when the display module 5 is operated in the first displaying mode, and to the second character 34 when the display module 5 is operated in the second displaying mode.

In use, the keyboard module 31 is pulled to extend out of the keyboard-accommodating cavity 25 through the access opening 27. At this time, the user can input information by typing on the keys 311 of the keyboard module 31. To conceal the keyboard module 31, the keyboard module 3 is pushed to retract the same into the keyboard-accommodating cavity 25 through the access opening 27.

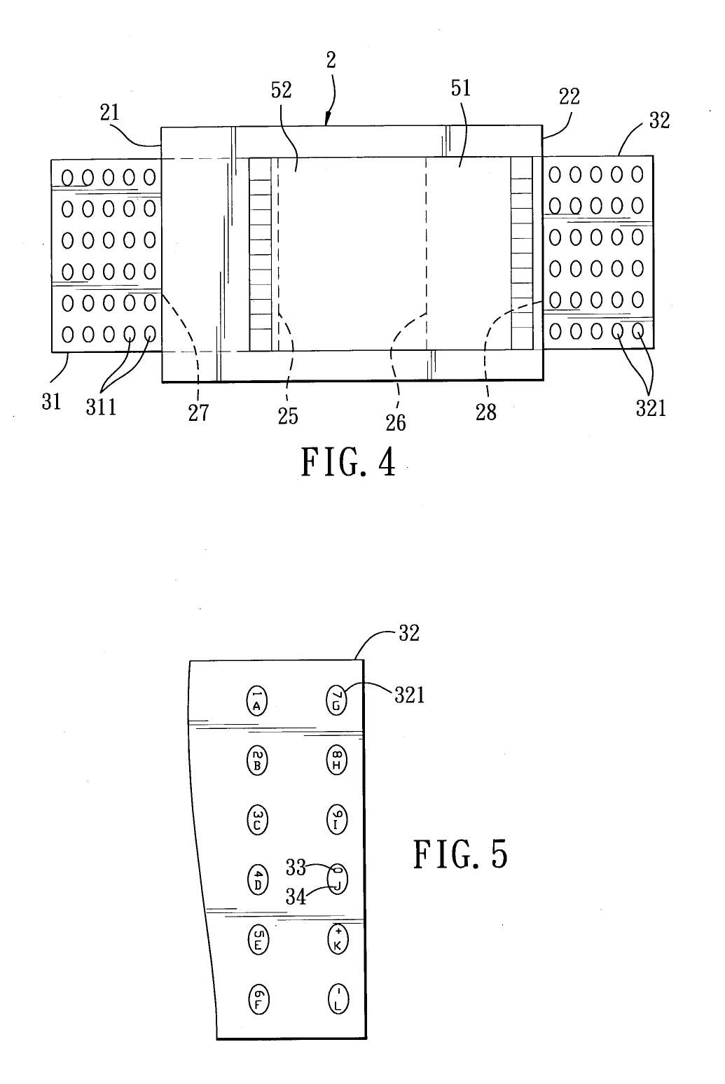

FIG. 4 shows the second preferred embodiment of a portable electronic device 1 according to the present invention. This embodiment differs from the previous embodiment in that the housing 20 of the host module 2 further includes a second keyboard-accommodating cavity 26 that extends from the second lateral side 22 toward the first lateral side 21, and a second access opening 28 formed in the second lateral side 22 for access into the second keyboard-accommodating cavity 26.

With further reference to FIG. 5, a second keyboard module 32 is coupled electrically to the host circuit 29 (see FIG. 2), is slidably disposed in the second keyboard-accommodating cavity 26, and includes a plurality of keys 321.

As in the previous embodiment, each of the keys 321 of the second keyboard module 32 is provided with a first character 33 oriented in the first direction and a second character 34 oriented in the second direction. The host circuit 29 is similarly configured to assign each of the keys 321 of the second keyboard module 32 with a first definition when the display module 5 is operated in the first displaying mode, and with a second definition when the display module 5 is operated in the second displaying mode.

Since operation of the second keyboard module 32 is similar to that described herein above in connection with the keyboard module 31 of the previous embodiment, a detailed description of the same will be dispensed with herein for the sake of brevity.

It has thus been shown that the portable electronic device of the of the present invention includes a keyboard module that is extendable out of and retractable into a keyboard-accommodating cavity in a housing of a host module. The construction as such results in enhanced flexibility and ease of use of the portable electronic device.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. 1. A portable electronic device comprising:
a host module including a housing with a first lateral side, a second lateral side opposite to said first lateral side in a first direction, a keyboard-accommodating cavity extending from said first lateral side toward said second lateral side, and an access opening formed in said first lateral side for access into said keyboard-accommodating cavity, said host module further including a host circuit disposed in said housing; and
a keyboard module coupled electrically to said host circuit and slidably disposed in said keyboard-accommodating cavity, said keyboard module being extendable out of and retractable into said keyboard-accommodating cavity through said access opening.

2. The portable electronic device as claimed in claim 1, wherein said housing of said host module further has a display surface between said first and second lateral sides, said portable electronic device further comprising a display module disposed on said display surface of said housing and coupled electrically to said host circuit.

3. The portable electronic device as claimed in claim 2, wherein said host circuit is configured to enable operation of said display module in a selected one of a first displaying mode, where said display module is oriented parallel to the first direction, and a second displaying mode, where said display module is oriented in a second direction transverse to the first direction.

4. The portable electronic device as claimed in claim 3, wherein said keyboard module includes a plurality of keys, each of said keys being provided with a first character oriented in the first direction and a second character oriented in the second direction.

5. The portable electronic device as claimed in claim 4, wherein said host circuit is configured to assign each of said keys with a first definition when said display module is operated in the first displaying mode, and with a second definition when said display module is operated in the second displaying mode.

6. The portable electronic device as claimed in claim 1, wherein said host module is one of a personal digital assistant, a tablet personal computer, and an electronic dictionary.

7. A portable electronic device comprising: a host module including a housing with a first lateral side, a second lateral side opposite to said first lateral side in a first direction, a first keyboard-accommodating cavity extending from said first lateral side toward said second lateral side, a first access opening formed in said first lateral side for access into said first keyboard-accommodating cavity, a second keyboard-accommodating cavity extending from said second lateral side toward said first lateral side, and a second access opening formed in said second lateral side for access into said second keyboard-accommodating cavity, said host module further including a host circuit disposed in said housing; and
first and second keyboard modules coupled electrically to said host circuit, and slidably and respectively disposed in said first and second keyboard-accommodating cavities, each of said first and second keyboard modules being extendable out of and retractable into the respective one of said first and second keyboard-accommodating cavities through a corresponding one of said first and second access openings.

8. The portable electronic device as claimed in claim 7, wherein said housing of said host module further has a display surface between said first and second lateral sides, said portable electronic device further comprising a display module disposed on said display surface of said housing and coupled electrically to said host circuit.

9. The portable electronic device as claimed in claim 8, wherein said host circuit is configured to enable operation of said display module in a selected one of a first displaying mode, where said display module is oriented parallel to the first direction, and a second displaying mode, where said display module is oriented in a second direction transverse to the first direction.

10. The portable electronic device as claimed in claim 9, wherein each of said first and second keyboard modules includes a plurality of keys, each of said keys being provided with a first character oriented in the first direction and a second character oriented in the second direction.

11. The portable electronic device as claimed in claim 10, wherein said host circuit is configured to assign each of said keys with a first definition when said display module is operated in the first displaying mode, and with a second definition when said display module is operated in the second displaying mode.

12. The portable electronic device as claimed in claim 7, wherein said host module is one of a personal digital assistant, a tablet personal computer, and an electronic dictionary.
